(19) United States
(12) Patent Application Publication
(10) Pub. No.: US 2011/0089815 A1
(43) Pub. Date: Apr. 21, 2011

(54) LIGHT-EMITTING DEVICE

(75) Inventors: Cheng-Kuo Yeh, Taipei (TW); Jui-Hung Sun, Taipei (TW)

(73) Assignee: AUROTEK CORPORATION, Taipei City (TW)

(21) Appl. No.: 12/902,280

(22) Filed: Oct. 12, 2010

(30) Foreign Application Priority Data
Oct. 15, 2009 (TW) 098134894

(51) Int. Cl. H01J 1/62; H01J 9/00

(52) U.S. Cl. 313/501; 445/58

(57) ABSTRACT

A light-emitting device includes a photonic crystal layer formed above a light-emitting chip and covered with a phosphor layer for diffusing light emitted from the light-emitting chip. The diffused light further excites the phosphor layer to emit colored light of multiple colors. The multiple colors are then mixed to generate white light.

### BACKGROUND OF THE INVENTION

1. Field of the Invention

The present invention relates generally to light-emitting devices, and more particularly, to a light-emitting device for generating white light through a light-emitting chip.

2. Description of Related Art

Light-emitting diodes (LEDs) have the advantages of small size, low energy consumption, long service life, high response speed, safe low voltage operation and better directivity, and therefore are expected to be widely applied in the fields of illumination and display. In recent years, as the luminous efficiency of LEDs has continuously increased, high-power white-light LEDs have gradually replaced conventional incandescent lamps, halogen lamps and phosphor lamps so as to become a new generation of environmentally-friendly light sources, especially when they are powered by solar cells.

Generally, a yellow YAG (Y₃Al₅O₁₂:Ce and its derivatives) phosphor is added to a blue-emitting chip to fabricate a white-light LED light source. However, such a white-light LED has the following drawbacks. Firstly, blue light accounts for the majority of the emission spectrum to thereby render the color temperature high and uneven. Hence, to decrease the intensity of blue light or increase the intensity of yellow light, excitation of the yellow phosphor by blue light needs to be strengthened, thereby increasing the fabrication cost. Further, in that the produced wavelengths of the blue-emitting LED will change following a rise in temperature, it is difficult to control the color temperature of the white light source. Furthermore, the weaker emission spectrum of yellow light leads to poor color rendition.

In addition, a RGB phosphor material can be added to and excited by a UV/blue-emitting LED chip so as to generate white light consisting of triple wavelengths, which has the advantage of high color rendition but low lighting efficiency.

Alternately, white light can be generated through an RGB-LED chip, which has the advantages of high lighting efficiency and high color rendition. However the generation of light from the RGB-LED chip does have a disadvantage. Depending on the epitaxy materials of the crystal particles for the different colors, the voltage characteristics are different, thereby resulting in higher costs, more complicated control of the wiring design and difficulty in mixing the three color wavelengths produced.

Taking into account costs and lighting efficiency, the method of forming white light by adding a yellow YAG phosphor to a blue-emitting chip is still the most efficient overall and represents the mainstream.

To fabricate a conventional LED light-emitting device, an LED chip is adhered to the reflector cup of a leadframe or a surface-mount device (SMD) base through an adhesive or a silver paste. Then, the electrodes of the LED chip are electrically connected to the leadframe or the base through gold wires or aluminum wires. Thereafter, the LED chip is coated with a phosphor before being packaged by an epoxy resin.

FIG. 1A shows a conventional light-emitting device. An LED chip 11 is disposed on an UV/visible light mirror 10a of a cup-shaped substrate 10. A short-wave-pass filter 13 is disposed on the top surface of the LED chip 11. A packaging layer 12 impregnated with phosphor grains 14 fills the cup-shaped substrate 10 to thereby encapsulate the LED chip 11 and the short-wave-pass filter 13. A glass plate 15 is disposed on the top of the substrate 10. However, after operating for a while, the LED chip generates heat, and the heat thus generated accumulates in the phosphor layer 14 to thereby adversely affect the service life of the phosphor and lead to light degradation and color offset.

FIG. 1B shows another conventional light-emitting device, wherein an LED chip 11′ is disposed inside a substrate 10′ having a light-transmissive cup shape. A curable layer 13′ is formed on the substrate 10′ to cover the LED chip 11′, and a phosphor layer 14′ is disposed on the curable layer 13′.

Light is emitted from the LED chip 11′ in all directions and therefore is not uniformly mixed with the phosphor of the phosphor layer 14′, thereby adding to the difficulty in controlling the color of the white light source.

Such disadvantages with the prior art limit the potential of LED lighting. Therefore, it is imperative to overcome the above-described drawbacks of the prior art.

### SUMMARY OF THE INVENTION

In view of the above drawbacks of the prior art, the present invention discloses a light-emitting device, which comprises: a substrate; a light-emitting chip disposed on the substrate; a packaging layer disposed on the substrate for encapsulating the light-emitting chip; a phosphor layer disposed on the packaging layer; and a photonic crystal layer disposed on the surface of the light-emitting chip or disposed between the packaging layer and the phosphor layer, the packaging layer being sandwiched between the phosphor layer and the substrate.

In the above-described light-emitting device, the light-emitting chip is a light-emitting diode (LED). Preferably, the light-emitting chip is a blue-emitting LED, and the phosphor layer comprises red and green phosphors and a protective material encapsulating the phosphors.

The packaging layer is made of an epoxy resin or a silicone resin, and the profile of the surface of the package layer is planar or curved. The photonic crystal layer comprises a plurality of nanoparticles.

The present invention further discloses a method for fabricating a light-emitting device, which comprises: disposing at least a light-emitting chip on a substrate; forming a packaging layer on the substrate to encapsulate the light-emitting chip; and forming a photonic crystal layer and a phosphor layer on the packaging layer such that the photonic crystal layer is sandwiched between the packaging layer and the phosphor layer.

Therein, the step of forming the photonic crystal layer and the phosphor layer further comprises providing a thin film comprising the phosphor layer and the photonic crystal layer, and covering the surface of the packaging layer with the thin film such that the photonic crystal layer is sandwiched between the packaging layer and the phosphor layer. In other embodiments, the photonic crystal layer is formed on the packaging layer and the phosphor layer is further formed on the photonic crystal layer such that the photonic crystal layer is sandwiched between the packaging layer and the phosphor layer.

The present invention further discloses another method for fabricating a light-emitting device, which comprises: disposing at least a light-emitting chip on a substrate; forming a photonic crystal layer on the surface of the light-emitting chip; forming a packaging layer on the substrate to encapsulate the light-emitting chip and the photonic crystal layer; and forming a phosphor layer on the packaging layer.

In the above-described two methods, the light-emitting chip is a light-emitting diode (LED). Preferably, the light-emitting chip is a blue-emitting LED, and the phosphor layer comprises red and green phosphors and a protective material encapsulating the phosphors. The packaging layer is made of an epoxy resin or a silicone resin, and the profile of the surface of the package layer is planar or curved. The photonic crystal layer comprises a plurality of nanoparticles and is formed by imprinting or E-beam lithography (EBL).

Therefore, the present invention uses the photonic crystal layer to disrupt the total reflection characteristic of the packaging layer such that light emitted from the LED chip can be diffused and emitted out of the packaging layer instead of being limited inside the packaging layer due to the total reflection, thereby efficiently improving the light extracting efficiency and overcoming the conventional drawback of low lighting efficiency.

Further, the phosphor layer is disposed outside the packaging layer so as to not be directly affected by heat generated by the LED chip, thereby reducing damage to the phosphor layer due to heat exposure, extending the service life of the phosphor layer and allowing sufficient excitation by the LED chip and good light mixing. As such, highly efficient light output is achieved and the drawbacks of light degradation and color offset are overcome.

### BRIEF DESCRIPTION OF DRAWINGS

FIGS. 1A and 1B are cross-sectional side views of conventional light-emitting devices;

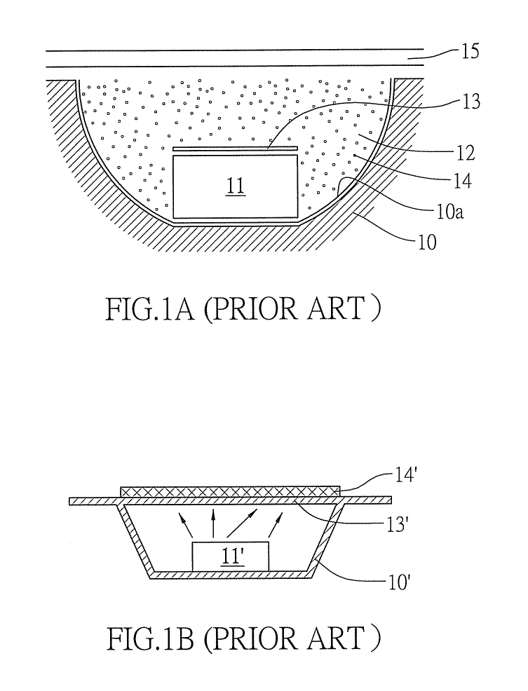

FIGS. 2A to 2D are cross-sectional side views showing a method for fabricating a light-emitting device according to a first embodiment of the present invention;

FIG. 2D′ is a cross-sectional side view showing another embodiment of the step of FIG. 2D, and FIG. 2D″ is a cross-sectional side view showing another embodiment of the substrate structure of the light-emitting device;

FIGS. 3A to 3D are cross-sectional side views showing a method for fabricating a light-emitting device according to a second embodiment of the present invention; and

FIG. 3D′ is a cross-sectional side view showing another embodiment of the packaging layer of the light-emitting device.

### DETAILED DESCRIPTION OF PREFERRED EMBODIMENTS

The following illustrative embodiments are provided to illustrate the disclosure of the present invention, these and other advantages and effects being apparent to those skilled in the art after reading the specification.

### First Embodiment

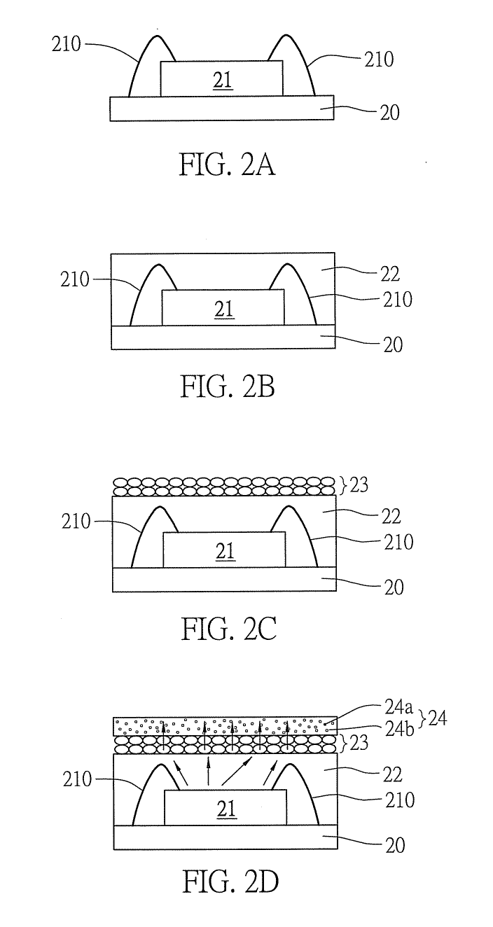

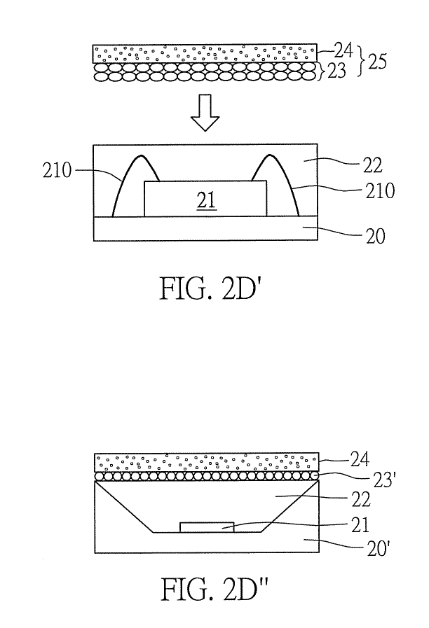

The present invention relates to an LED light source technique that combines a photonic crystal technique with a conventional packaging technique. FIGS. 2A to 2D show a method for fabricating a light-emitting device according to a first embodiment of the present invention.

As shown in FIG. 2A, at least a light-emitting chip 21 such as a light-emitting diode (LED) is disposed on a substrate 20 such as a circuit board, a leadframe or a reflector cup. The first embodiment is illustrated with a circuit board that serves as the substrate 20. In the first embodiment, the light-emitting chip 21 is a blue-emitting LED, and the light-emitting chip 21 is electrically connected to the substrate 20 through conductive wires 210. But it should be noted that the electrical connecting method is not limited to wire-bonding. Many other techniques already known in the art can be used. Since the electrical connecting method is not the characteristic of the present invention, detailed description thereof is omitted herein.

As shown in FIG. 2B, a packaging layer 22 made of a transparent adhesive material is formed on the substrate 20 to encapsulate the light-emitting chip 21 and the conductive wires 210. The packaging layer 22 may be made of an epoxy resin or a silicone resin. In the present embodiment, the profile of the surface of the packaging layer 22 is planar. In other embodiments, the profile of the surface of the packaging layer 22 can be curved as needed.

As shown in FIG. 2C, a photonic crystal layer 23 is formed on the packaging layer 22, the photonic crystal layer 23 comprising a plurality of nanoparticles regularly arranged in two layers. The photonic crystal layer 23 is made of the material of which an auto-focus layer disclosed in Taiwan Patent Publication No. 200835100 is made. In the present embodiment, the photonic crystal layer 23 is formed on the packaging layer 22 by E-beam lithography (EBL). Further, the photonic crystal layer 23 can be arranged according to the requirements of the light-emitting surface.

The photonic crystal layer 23 is disposed on the surface of the packaging layer 22 to disrupt the total reflection characteristic of the packaging layer 22 so as to allow light emitted from the LED chip to be diffused and emitted out of the packaging layer 22 instead of being confined to the packaging layer 22 due to the total reflection, thereby efficiently improving the light extracting efficiency.

As shown in FIG. 2D, a phosphor layer 24 is formed on the photonic crystal layer 23. The phosphor layer 24 comprises red and green light-producing phosphors 24a. A transparent protective material 24b encapsulates the phosphors 24a.

Blue light emitted from the blue-emitting chip 21 travels in a single direction instead of various directions upon penetrating the photonic crystal layer 23, as shown in FIG. 2D, so as for the blue light to uniformly excite the red and green phosphors of the phosphor layer 24 for emitting red light and green light, in addition to the blue light that passes unchanged. Then, the red, green and blue lights are sufficiently mixed to generate white light.

The present invention generates a white light source by adding red and green phosphors 24a to a blue-emitting chip 21. Therefore, the present invention has the advantage of high color rendition, which enables the color temperature of the white light source to be easily controlled. Further, the light extracting efficiency is improved through the photonic crystal layer 23, thereby overcoming the low light efficiency of the prior art.

Alternatively, as shown in FIG. 2D′, the photonic crystal layer 23 is formed on the phosphor layer 24 so as to form a thin film 25 comprising the photonic crystal layer 23 and the phosphor layer 24, and then the thin film 25 is imprinted to cover the surface of the packaging layer 22. As a result, the photonic crystal layer 23 is sandwiched between the packaging layer 22 and the phosphor layer 24.

Intended to integrate the technology related to the phosphor layer 24 with the technology related to the photonic crystal layer 23, the present invention uses a photonic crystal layer 23 to disrupt the total reflection of the packaging layer so as to improve the light-extracting efficiency. Further, the phosphor layer 24 of the present invention is disposed on the photonic crystal layer 23 instead of directly encapsulating an LED chip as in the prior art. Thus, the photonic crystal layer 23 serves as an intermediate buffer between the phosphors 24a and the light-emitting chip 21 so as to prevent heat generated by the light-emitting chip 21 from directly affecting the phosphors 24a, thereby preventing damage which might otherwise occur to the phosphors 24a due to the heat, extending the service life of the phosphors 24a and allowing sufficient excitation with plenty of light from the light-emitting chip 21 and light mixture. As such, a highly efficient light output is achieved.

The present invention further provides a light-emitting device, comprising: a substrate 20; a light-emitting LED chip 21 disposed on the substrate 20; a packaging layer 22 disposed on the substrate 20a for encapsulating the light-emitting chip 21, wherein the packaging layer 22 may be made of an epoxy resin or a silicone resin, and the profile surface of the packaging layer 22 is a planar surface or a curved surface; a phosphor layer 24 disposed on the packaging layer 22; and a photonic crystal layer 23 disposed between the packaging layer 22 and the phosphor layer 24 and comprising a plurality of nanoparticles.

The phosphor layer 24 comprises red and green phosphors 24a. A transparent protective material 24b encapsulates the phosphors 24a.

Further, as shown in FIG. 2D″, a substrate 20′ is provided, which is a reflector cup with its opening facing upwards. At least a light-emitting chip 21 is disposed in the opening of the substrate 20′. The packaging layer 22 fills the opening to thereby encapsulate the light-emitting chip 21 so as to protect the light-emitting chip 21 against external erosion. Another purpose of the packaging layer 22 is to allow the reflector cup to collect light emitted from interface surfaces and side surfaces of the light-emitting chip 21. A photonic crystal layer 23′ comprising a plurality of nanoparticles and a phosphor layer 24 comprising red and green phosphors are sequentially formed on the packaging layer 22 so as to form a light-emitting device.

### Second Embodiment

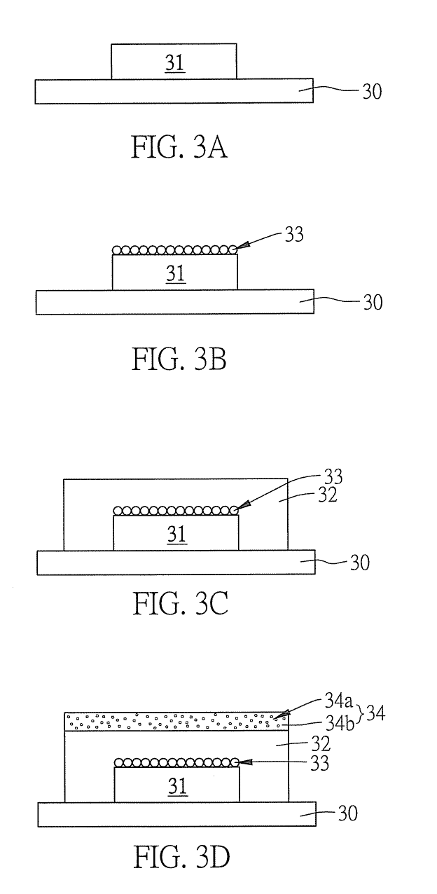

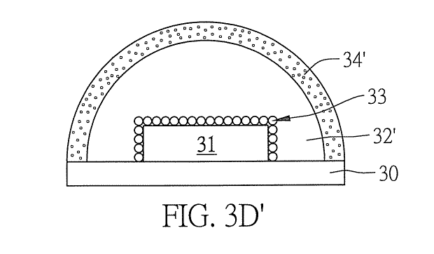

FIGS. 3A to 3D show a method for fabricating a light-emitting device according to a second embodiment of the present invention. The second embodiment is mostly similar to the first embodiment, but the second embodiment differs from the first embodiment in terms of the position of the photonic crystal layer. Therefore, description of similar parts of the first and second embodiments is omitted herein, and the differences between the first and second embodiments are detailed as follows.

As shown in FIG. 3A, at least a light-emitting chip 31 is disposed on a substrate 30.

As shown in FIG. 3B, a photonic crystal layer 33 is formed on the surface of the light-emitting chip 31. The photonic crystal layer 33 comprises a plurality of nanoparticles arranged in one layer. The photonic crystal layer 33 is formed on the light-emitting chip 31 by imprinting or E-beam lithography (EBL).

As shown in FIG. 3C, a packaging layer 32 is formed on the substrate 30 to encapsulate the light-emitting chip 31 and the photonic crystal layer 33. The photonic crystal layer 33 is disposed on the surface of the light-emitting chip 31 to prevent total reflection of light from taking place at the interface of the light-emitting chip 31 in the packaging layer 32, thereby allowing the light emitted from the light-emitting chip 31 to be diffused and emitted out of the packaging layer 32 and accordingly increasing the light extracting efficiency.

As shown in FIG. 3D, a phosphor layer 34 is formed on the packaging layer 32. Further, as shown in FIG. 3D′, in other embodiments, the profile of the surface of the packaging layer 32′ can be curved such as hemispherical, and the phosphor layer 34′ is formed in a shape corresponding to the profile of the packaging layer 32′.

Further, the photonic crystal layer 33 can be arranged according to the shape of the light-emitting surface of the light-emitting chip 31, as shown in FIG. 3D′.

The present invention further provides a light-emitting device, comprising: a substrate 30; a light-emitting LED chip 31 disposed on the substrate 30; a packaging layer 32 disposed on the substrate 30 for encapsulating the light-emitting chip 31, wherein the packaging layer 32 is made of an epoxy resin or a silicone resin and the profile of the surface of the packaging layer 32 is planar or curved; a photonic crystal layer 33 disposed on the surface of the light-emitting chip 31 and comprising a plurality of nanoparticles; and a phosphor layer 34 disposed on the packaging layer 32.

The phosphor layer 34 comprises red and green phosphors 34a. A protective material 34b encapsulates the phosphors 34a.

The phosphor layers 24, 34 are disposed to the outside of the packaging layers 22, 32 so as not to be in direct contact with the light-emitting chips 21, 31, thereby efficiently preventing heat generated by the light-emitting chips 21, 31 from adversely affecting the service life of the phosphors 24a, 34a of the phosphor layers 24, 34 and avoiding the conventional drawbacks of light degradation and color offset.

Further, the present invention uses the photonic crystal layers 23, 33 to collect and guide light such that light emitted from the light-emitting chips 21, 31 can uniformly enter the phosphor layers 24, 34 and sufficiently mix with the phosphors 24a, 34a, thereby efficiently generating white light with good color.

Therefore, the present invention uses the photonic crystal layer to disrupt the total reflection characteristic of the packaging layer such that light emitted from the LED chip can be diffused and emitted out of the packaging layer instead of being confined to the packaging layer due to the total reflection, thereby efficiently improving the light extracting efficiency.

Further, the phosphor layer is disposed outside the packaging layer so as to not be directly affected by heat generated by the LED chip, thereby reducing damage which might otherwise occur to the phosphor layer due to the heat, extending the service life of the phosphor layer and allowing sufficient excitation with plenty of light from the LED chip and good light mixing. As such, highly efficient light output is achieved.

The above-described descriptions of the detailed embodiments are intended to illustrate the preferred implementation according to the present invention but are not intended to limit the scope of the present invention. Accordingly, many modifications and variations can be made to the embodiments by persons skilled in the art should and yet still fall within the scope of present invention defined by the appended claims.

What is claimed is:

1. A light-emitting device, comprising:
a substrate;
a light-emitting chip disposed on the substrate;
a packaging layer formed on the substrate for encapsulating the light-emitting chip;
a photonic crystal layer formed over the light-emitting chip corresponding in position to the light-emitting chip; and
a phosphor layer formed on the packaging layer in a manner that the packaging layer is sandwiched between the phosphor layer and the substrate.

2. The device of claim 1, wherein the light-emitting chip is a light-emitting diode (LED).

3. The device of claim 1, wherein the light-emitting chip is a blue-emitting LED.

4. The device of claim 3, wherein the phosphor layer comprises red and green phosphors.

5. The device of claim 4, wherein the phosphor layer further comprises a protective material encapsulating the phosphors.

6. The device of claim 1, wherein a surface of the packaging layer is a planar surface or a curved surface.

7. The device of claim 1, wherein the packaging layer is made of an epoxy resin or a silicone resin.

8. The device of claim 1, wherein the photonic crystal layer is directly formed on a surface of the light-emitting chip.

9. The device of claim 1, wherein the photonic crystal layer is disposed between the packaging layer and the phosphor layer.

10. The device of claim 1, wherein the photonic crystal layer comprises a plurality of nanoparticles.

11. A method for fabricating a light-emitting device, comprising the steps of:
disposing at least a light-emitting chip on a substrate;
forming a packaging layer on the substrate to encapsulate the light-emitting chip; and
forming a photonic crystal layer and a phosphor layer on the packaging layer such that the photonic crystal layer is sandwiched between the packaging layer and the phosphor layer.

12. The method of claim 11, wherein the light-emitting chip is a light-emitting diode (LED).

13. The method of claim 11, wherein the light-emitting chip is a blue light-emitting diode (LED).

14. The method of claim 13, wherein the phosphor layer comprises red and green phosphors.

15. The method of claim 14, wherein the phosphor layer further comprises a protective material encapsulating the phosphors.

16. The method of claim 11, wherein the profile of the surface of the packaging layer is planar or curved.

17. The method of claim 11, wherein the packaging layer is made of an epoxy resin or a silicone resin.

18. The method of claim 11, wherein the photonic crystal layer comprises a plurality of nanoparticles.

19. The method of claim 11, wherein the photonic crystal layer is formed on the packaging layer by imprinting.

20. The method of claim 11, wherein the photonic crystal layer is formed on the packaging layer by E-beam lithography (EBL).

21. The method of claim 11, wherein the step of forming the photonic crystal layer and the phosphor layer further comprises providing a thin film comprising the phosphor layer and the photonic crystal layer, and covering the surface of the packaging layer with the thin film such that the photonic crystal layer is sandwiched between the packaging layer and the phosphor layer.

22. The method of claim 11, wherein the method of forming the photonic crystal layer and the phosphor layer further comprises forming the photonic crystal layer on the packaging layer and forming the phosphor layer on the photonic crystal layer such that the photonic crystal layer is sandwiched between the packaging layer and the phosphor layer.

23. A method for fabricating a light-emitting device, comprising the steps of:
disposing at least a light-emitting chip on a substrate;
forming a photonic crystal layer on the surface of the light-emitting chip;
forming a packaging layer on the substrate to encapsulate the light-emitting chip and the photonic crystal layer; and
forming a phosphor layer on the packaging layer.

24. The method of claim 23, wherein the light-emitting chip is a light-emitting diode (LED).

25. The method of claim 23, wherein the light-emitting chip is a blue light-emitting diode (LED).

26. The method of claim 25, wherein the phosphor layer comprises red and green phosphors.

27. The method of claim 26, wherein the phosphor layer further comprises a protective material encapsulating the phosphors.

28. The method of claim 23, wherein a surface of the packaging layer is planar or curved.

29. The method of claim 23, wherein the packaging layer is made of an epoxy resin or a silicone resin.

30. The method of claim 23, wherein the photonic crystal layer comprises a plurality of nanoparticles.

31. The method of claim 23, wherein the photonic crystal layer is formed on the packaging layer by imprinting.

32. The method of claim 23, wherein the photonic crystal layer is formed on the packaging layer by E-beam lithography (EBL).
